(19) United States
(12) Patent Application Publication
(10) Pub. No.: US 2006/0078374 A1
(43) Pub. Date: Apr. 13, 2006

(54) Ergonomic pin and clip

(76) Inventors: Ronald H. Wrase, Savage, MN (US); Bruce E. Kyro, Prior Lake, MN (US)

Correspondence Address: WALTER K. ROLOFF, 490 HARBOR COURT, SHOREVIEW, MN, 55126, US

(21) Appl. No.: 10/940,189

(22) Filed: Sep. 13, 2004

(51) Int. Cl. F16B 21/09

(52) U.S. Cl. 403/315

(57) ABSTRACT

An ergonomic pin and clip, for securing a receiving member and for securing the pin in the receiving member to prevent unintentional disengagement of the pin from the receiving member, respectively, includes a pin having a pin body with at least one elongated portion and at least one grip portion. The elongated portion of the pin is configured to engage and disengage the receiving member as desired by a user, and the grip portion of the pin is configured to be angled relative to the elongated portion, and to provide ergonomic gripping thereof by the user. Likewise, a clip or pin retaining device includes a clip body having an engagement portion and at least one grip portion. The engagement portion of the clip is configured to engage and disengage the pin, and the grip portion of the clip is configured to be angled relative to the engagement portion, and to provide ergonomic gripping thereof by the user.

### FIELD OF THE INVENTION

The present invention relates generally to securing pins and clips. The invention relates specifically to an ergonomic pin and clip for securing a receiving member such as a trailer hitch.

### BACKGROUND OF THE INVENTION

Pins and clips for securing receiving members are well known. Typically, in combination, they are simple mechanical devices, being constructed from only a few metal parts.

The pins, individually, are typically constructed from a hardened metal and are simply required to be durable and capable of withstanding heavy loads. Other pins are intended to shear under excessive loads, to prevent damage to associated components. Aside from physical dimension requirements, pins are for the most part very basic in design. Like the pins, the clips (or “pin retaining devices”) are also well known. So-called “quick connect/disconnect” or “hair pin” type securing clips, as well as “bridge pin clips” or “cotter pin clips” among others (collectively, also, “pin clips”) are typically utilized in combination with a pin which, together, prevent disengagement of a pin from a receiving member such as, for example, a trailer hitch assembly. In a particular use, the clip is inserted into a hole of, or is otherwise forcibly engaged with, the pin to prevent the pin from being unintentionally disengaged from the receiving member. The clip prevents the pin from moving excessively due to forces that would tend to cause the pin to “back out” from the receiving member.

Those who have used such conventional pins and clips appreciate how difficult they may be to manipulate, particularly in cold temperatures or when one does not have full use of fingers or a hand due to wearing a glove or mitten. Those with physical disabilities, such as missing fingers or a lack of strength or dexterity, also experience significant difficulties in attempting to use known pins and clips. Often, hand injuries result from a loss of one's grip on the pin and/or clip, or from the pin finally releasing under force from the user, and consequent accidental forceful impact with a nearby assembly. Relatively small clip dimensions can painfully cut into a user's skin. Also, as too often experienced by sportsmen while attempting to hitch a trailer to a vehicle, known pins and clips are notoriously easy to lose when accidentally dropped into snow or water. Thus, the known pins and clips are often anything but quickly connected or disconnected, or easy to use. Often, in cold environments, a user must use bare hands to manipulate pins and clips. Since a vast majority of pins and clips are fabricated from metal, substantial discomfort and even hypothermic injury can result from such manipulations.

Therefore, there exists a need for an ergonomic pin and clip which overcomes the drawbacks of the well known pins and clips. There also exists a need, generally, for a pin and clip which is easier to use, particularly for those with physical disabilities.

### SUMMARY OF THE INVENTION

An object of the present invention is to provide an ergonomic pin and clip which are generally easy to use.

Another object of the present invention is to provide an ergonomic pin and clip which are specifically easy to use by those with disabilities or having problems with manual dexterity.

A further object of the present invention is to provide an ergonomic pin and clip which tend to prevent injuries, in use

A still further object of the present invention is to provide an ergonomic pin and clip which are easy to find after being accidentally dropped.

A yet further object of the present invention is to provide an ergonomic pin and clip which minimize discomfort when manipulated in cold environments.

In accordance with the present invention, an ergonomic pin and clip, for securing a receiving member and for securing the pin in the receiving member to prevent unintentional disengagement of the pin from the receiving member, respectively, includes a pin having a pin body with at least one elongated portion and at least one grip portion. The elongated portion of the pin is configured to engage and disengage the receiving member as desired by a user, and the grip portion of the pin is configured to be angled relative to the elongated portion, and to provide ergonomic gripping thereof by the user. Likewise, a clip or pin retaining device includes a clip body having an engagement portion and at least one grip portion. The engagement portion of the clip is configured to engage and disengage the pin, and the grip portion of the clip is configured to be angled relative to the engagement portion, and to provide ergonomic gripping thereof by the user.

### BRIEF DESCRIPTION OF THE DRAWINGS

FIG. 1 is a perspective illustration of a pin and clip of the prior art.

FIG. 2 is a perspective illustration of an exemplary ergonomic pin and clip, constructed in accordance with the present invention.

FIG. 2a is a profile illustration of the ergonomic clip of FIG. 2, taken along reference line 2a-2a.

FIG. 2b is an illustration of an alternative embodiment of an ergonomic pin, constructed in accordance with the present invention.

FIG. 2c is an illustration of an alternative embodiment of an ergonomic clip, constructed in accordance with the present invention.

### DETAILED DESCRIPTION OF THE INVENTION

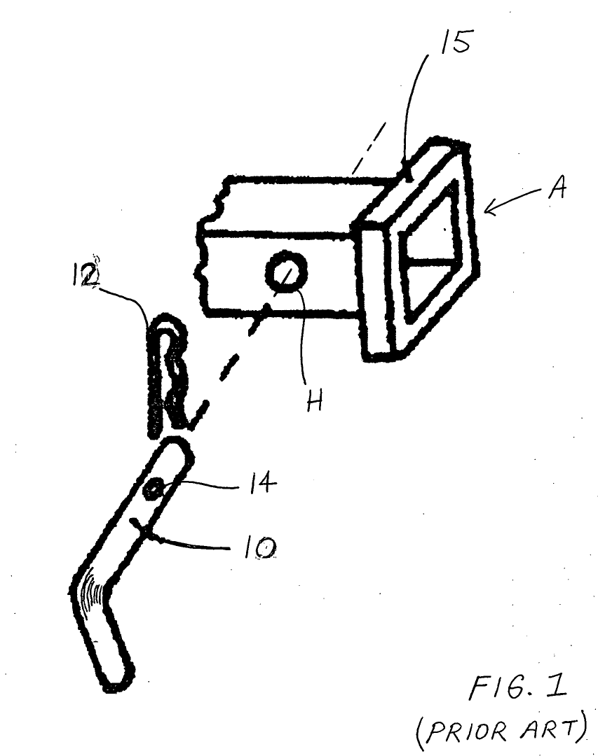

Referring to FIG. 1, a common prior art pin 10, clip (or pin retaining device) 12, and receiving member (or “receiver”) 15 are shown as components of, by way of example, a typical trailer hitch. In well known use of these exemplary components, a trailer hitch or “ball assembly” (not shown) is slid into receiver 15 at receiver aperture A. The ball assembly includes a hole there throughout, which upon sliding the assembly into aperture A is aligned by a user with holes H on opposite sides of receiver 15, in concentric alignment with each other (only one hole H of receiver 15 is depicted in the figure, the other being hidden). With the hole throughout the ball assembly (again, not shown) in alignment with holes H of receiver 15, pin 10 is then slid into one hole H of receiver 15, then through the hole throughout the ball assembly, and finally through the opposite hole H of receiver 15; pin 10 thus protrudes from both sides of receiver 15 with the ball assembly being securely held in place thereby. Clip 12 is then inserted into hole 14 of pin 10 in conventional fashion, to prevent pin 10 from being unintentionally disengaged or “backing out” from receiver 15 and the ball assembly. A bend as shown in pin 10 prevents pin 10 from passing fully through receiver 15 and the assembly; thus, due to the presence of clip 12 in hole 14 and the bend in pin 10, lateral movement of pin 10 is limited. So secured, as is well understood, pin 10 thus prevents unintentional disengagement of the ball assembly from receiver 15. Due to significant loads commonly imparted to the ball assembly and the aforedescribed components in use, and in particular pin 10, high-grade and high-strength metals such as hardened steel are commonly used for fabrication thereof. Although depicted as a bent cylindrical pin having hole 14 there throughout, pin 10 could of course take many forms such as a channeled or bored load-bearing member of virtually any useful dimensions, where clip 12 would engage the particular channel or bore.

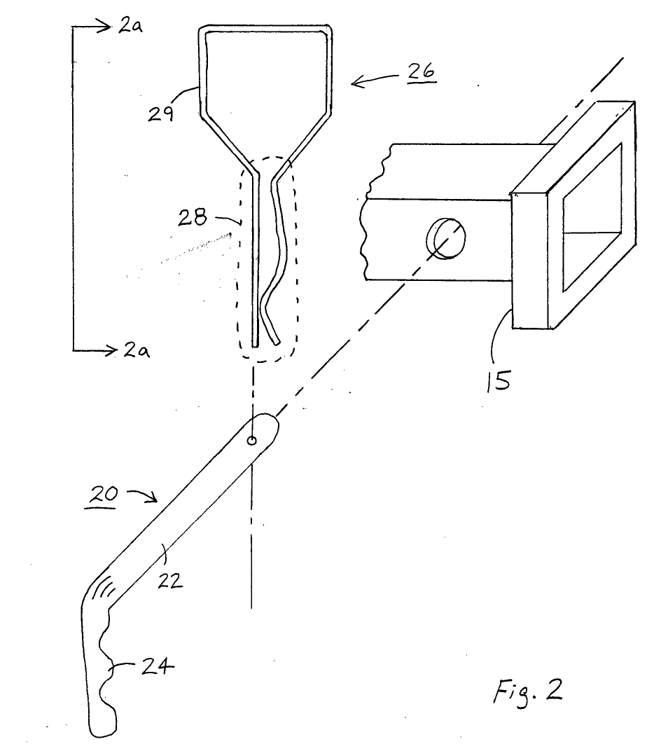

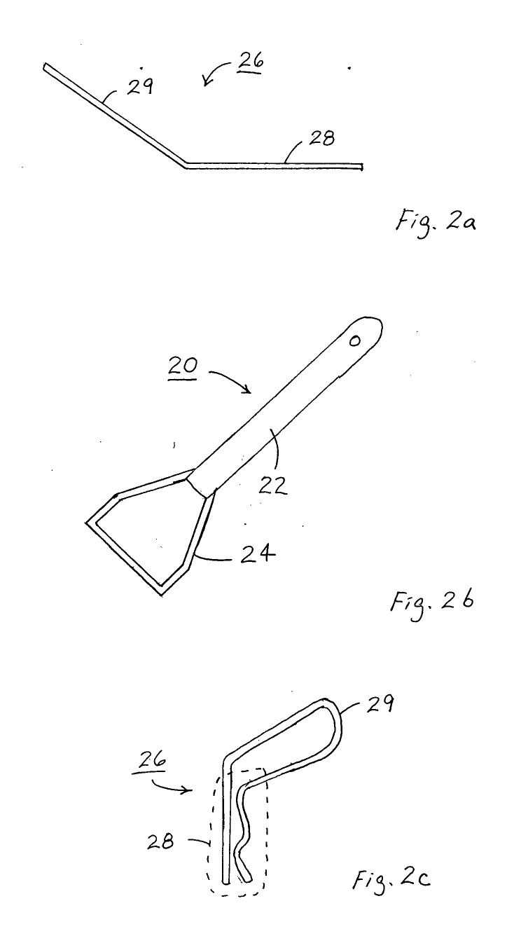

To overcome the drawbacks of the prior art pins and clips as described above, the present invention provides novel and heretofore unknown features in a pin and clip. Specifically, with reference to FIG. 2, an ergonomic pin 20 and ergonomic clip (or, “ergonomic pin retaining device”) 26 of the present invention are depicted with a typical receiving member (receiver 15 of FIG. 1). Ergonomic pin 20 includes an elongated pin body 22 that is designed to engage and disengage receiver 15, and a grip portion 24. Grip portion 24 is designed to (i) be angled relative to elongated pin body 22, and (ii) provide ergonomic gripping thereof by a user. In this regard, and with comparison to the prior art pin 10 of FIG. 1, it will be appreciated that grip portion 24 of ergonomic pin 20 is configured to adapt to a natural, typical conformation of fingers and/or a hand (“physique”) of a user, unlike the known pins. Specifically, grip portion 24 is configured to accommodate not just one but several fingers of a user's hand; also, portion 24 is preferably angled (although not required to be so) relative to pin body 22 to increase leverage thereon, particularly when forcibly removing pin 20 from receiver 15.

Although not illustrated, all or a selected portion of grip portion 24 of ergonomic pin 20 may be a soft material, to further enhance ergonomics. The soft material, such as may be provided by a so-called PVC plastisol, a fluidized bed plastisol coating, a plastisol dip molding, or other compliant material, may also advantageously be an insulating material. An insulating material may be of particular benefit when utilizing the pin in cold temperatures. Furthermore, the soft material may also be itself a selected color or separately colored as such by paint, for example. The selected color could be of high-visibility, or be a trademarked or brand-identifiable color as may be desired in a particular use of the present invention. A high-visibility material may be of particular benefit when the pin would be subject to being accidentally dropped in water or snow. Of course, portion 24 could advantageously be any combination of soft, insulating, and selected color materials.

With continued reference to FIG. 2, ergonomic clip or pin retaining device 26 includes a pin retaining device body 28 that is designed to engage and disengage pin 20, and a grip portion 29. Grip portion 29, analogously to grip portion 24 of pin 20, is designed to (i) be angled relative to pin retaining device body 28, and (ii) provide ergonomic gripping thereof by a user. In this regard, and with comparison once again to the prior art clip 12 of FIG. 1, it will be appreciated that grip portion 29 of ergonomic clip 26 is configured to adapt to a natural, typical conformation of the physique of a user, unlike the known clips. Specifically, grip portion 29, like grip portion 24 of pin 20, could be configured to accommodate not just one but several fingers of a user's hand; also, portion 29 is preferably angled (although not required to be so) relative to body 28 as shown in FIG. 2a, to increase leverage thereon, particularly when forcibly removing clip 26 from pin 20. Such preferred angulation of portion 29 to body 28 also would increase a user's clearance from receiver 15, thereby minimizing any likelihood of painful impact therewith. Like grip portion 24 of pin 20, and again although not illustrated, all or a selected portion of grip portion 29 of clip 26 may be a soft or conforming, complimentarily shaped material, to further enhance ergonomics as aforedescribed relative to pin 20. The material may be any combination of soft, insulating, and selected color materials as aforedescribed.

With reference now to FIGS. 2b and 2c, depicted are alternative embodiments of pin 20 and clip 26, respectively. It is to be appreciated that such exemplary embodiments of the inventive, ergonomic concept of the present invention have heretofore not been known in the art. In FIGS. 2b-2c, it is to be understood that grip portions 24 and 29, respectively, may be angled relative to bodies 22 and 28, for enhanced ergonomic effects.

Preferred materials for construction of pin 20 and clip 26 are carbon steel or stainless steel.

Regarding an angle that may be advantageously provided between the grip portions and bodies of the pins and clips of the present invention, approximately 45 degrees is preferred; but any angle may be utilized that is consistent with ergonomic considerations and effects.

It is to be appreciated that although shown in FIG. 2 as a combination, pin 20 and clip 26 of the present invention may be advantageously utilized separately, with corresponding prior art clips and pins, respectively.

It is to be particularly appreciated that the pin and clip of the present invention may be advantageously used by those having physical disabilities, such as missing fingers, limited use of fingers or hands, or a lack of manual dexterity.

While the present invention has been particularly shown and described with reference to the accompanying figures, it will be understood, however, that other modifications thereto are of course possible, all of which are intended to be within the true spirit and scope of the present invention. It should be appreciated that components of the invention aforedescribed may be substituted for other suitable components for achieving desired results, or that various accessories may be added thereto.

Lastly, the choice, of course, of compositions, sizes, and strengths of various aforementioned components of the present invention are all a matter of design choice depending upon intended uses thereof.

Accordingly, these and other various changes or modifications in form and detail of the present invention may also be made therein, again without departing from the true spirit and scope of the invention as defined by the appended claims.

We claim:

1. An ergonomic pin for securing a receiving member, said ergonomic pin comprising:
a pin body having (i) at least one elongated portion and (ii) at least one grip portion,
wherein (i) said at least one elongated portion is configured to engage and disengage the receiving member as desired by a user, and (ii) said at least one grip portion is configured to (a) be angled relative to said elongated portion, and (b) provide ergonomic gripping thereof by a user.

2. The ergonomic pin of claim 1, wherein said at least one grip portion of said pin body is configured to adapt to a natural, typical conformation of a physique of a user.

3. The ergonomic pin of claim 1, further comprising a soft material as a selected portion of said at least one grip portion.

4. The ergonomic pin of claim 2, further comprising a soft material as a selected portion of said at least one grip portion.

5. The ergonomic pin of claim 3, wherein said soft material is also an insulating material.

6. The ergonomic pin of claim 4, wherein said soft material is also an insulating material.

7. The ergonomic pin of claim 3, wherein said soft material is also a material of a selected color.

8. The ergonomic pin of claim 4, wherein said soft material is also a material of a selected color.

9. The ergonomic pin of claim 5, wherein said soft material is also a material of a selected color.

10. The ergonomic pin of claim 6, wherein said soft material is also a material of a selected color.

11. An ergonomic pin retaining device, for securing a pin in a receiving member to prevent unintentional disengagement of the pin from the receiving member, said ergonomic pin retaining device comprising:
a pin retaining device body, said pin retaining device body having (i) an engagement portion and (ii) at least one grip portion,
wherein (i) said engagement portion is configured to engage and disengage a pin as desired by a user, and (ii) said at least one grip portion is configured to (a) be angled relative to said engagement portion, and (b) provide ergonomic gripping thereof by a user.

12. The ergonomic pin retaining device of claim 11, wherein said at least one grip portion of said pin retaining device body is configured to adapt to a natural, typical conformation of a physique of a user.

13. The ergonomic pin retaining device of claim 11, further comprising a soft material as a selected portion of said at least one grip portion.

14. The ergonomic pin retaining device of claim 12, further comprising a soft material as a selected portion of said at least one grip portion.

15. The ergonomic pin retaining device of claim 13, wherein said soft material is also an insulating material.

16. The ergonomic pin retaining device of claim 14, wherein said soft material is also an insulating material.

17. The ergonomic pin retaining device of claim 13, wherein said soft material is also a material of a selected color.

18. The ergonomic pin retaining device of claim 14, wherein said soft material is also a material of a selected color.

19. The ergonomic pin retaining device of claim 15, wherein said soft material is also a material of a selected color.

20. The ergonomic pin retaining device of claim 16, wherein said soft material is also a material of a selected color.

21. A combination of an ergonomic pin and ergonomic pin retaining device, for securing a receiving member and for securing said pin in said receiving member to prevent unintentional disengagement of said pin from said receiving member, respectively, said combination of said ergonomic pin and ergonomic pin retaining device comprising:
(I) a pin body having (i) at least one elongated portion and (ii) at least one grip portion,
wherein (i) said at least one elongated portion is configured to engage and disengage the receiving member as desired by a user, and (ii) said at least one grip portion is configured to (a) be angled relative to said elongated portion, and (b) provide ergonomic gripping thereof by a user; and
(II) a pin retaining device body, said pin retaining device body having (i) an engagement portion and (ii) at least one grip portion,
wherein (i) said engagement portion is configured to engage and disengage a pin as desired by a user, and (ii) said at least one grip portion is configured to (a) be angled relative to said engagement portion, and (b) provide ergonomic gripping thereof by a user.

22. The combination of claim 21, wherein said at least one grip portion of said pin body is configured to adapt to a natural, typical conformation of a physique of a user.

23. The combination of claim 21, further comprising a soft material as a selected portion of said at least one grip portion of said pin body.

24. The combination of claim 22, further comprising a soft material as a selected portion of said at least one grip portion of said pin body.

25. The combination of claim 23, wherein said soft material is also an insulating material.

26. The combination of claim 24, wherein said soft material is also an insulating material.

27. The combination of claim 23, wherein said soft material is also a material of a selected color.

28. The combination of claim 24, wherein said soft material is also a material of a selected color.

29. The combination of claim 25, wherein said soft material is also a material of a selected color.

30. The combination of claim 26, wherein said soft material is also a material of a selected color.

31. The combination of claim 21, wherein said at least one grip portion of said pin retaining device body is configured to adapt to a natural, typical conformation of a physique of a user.

32. The combination of claim 21, further comprising a soft material as a selected portion of said at least one grip portion of said pin retaining device.

33. The combination of claim 31, further comprising a soft material as a selected portion of said at least one grip portion of said pin retaining device.

34. The combination of claim 32, wherein said soft material is also an insulating material.

35. The combination of claim 33, wherein said soft material is also an insulating material.

36. The combination of claim 32, wherein said soft material is also a material of a selected color.

37. The combination of claim 33, wherein said soft material is also a material of a selected color.

38. The combination of claim 34, wherein said soft material is also a material of a selected color.

39. The combination of claim 35, wherein said soft material is also a material of a selected color.
